(19) United States
(12) Patent Application Publication
(10) Pub. No.: US 2026/0275923 A1
(43) Pub. Date: Sep. 17, 2026

(54) CONTROL DEVICE AND METHOD FOR INTERNAL COMBUSTION ENGINE

(71) Applicant: MITSUBISHI HEAVY INDUSTRIES ENGINE & TURBOCHARGER, LTD., Sagamihara-shi, Kanagawa (JP)

(72) Inventors: Yusuke IMAMORI, Tokyo (JP); Hiroyuki UEDA, Tokyo (JP); Takafumi TANAKA, Kanagawa (JP); Ryosuke KOGURE, Kanagawa (JP)

(73) Assignee: MITSUBISHI HEAVY INDUSTRIES ENGINE & TURBOCHARGER, LTD., Sagamihara-shi, Kanagawa (JP)

(21) Appl. No.: 19/168,637

(22) PCT Filed: Dec. 26, 2023
(86) PCT No.: PCT/JP2023/046677

§ 371 Date: Sep. 24, 2025

(30) Foreign Application Priority Data
Mar. 28, 2023 (JP) 2023-051780

(51) Int. Cl. F02D 19/08; F02D 1/02; F02D 19/06; F02D 41/00

(52) U.S. Cl. CPC F02D 19/081; F02D 1/02; F02D 41/0025; F02D 19/0644

(57) ABSTRACT

In a control device and method for an internal combustion engine that supplies to a combustion chamber a first fuel having certain ignitability and a second fuel having lower ignitability than the first fuel, an operating state detector detects an operating state of the internal combustion engine, and a controller controls supply amounts of the first fuel and the second fuel to be supplied to the combustion chamber based on an operating state of the internal combustion engine detected by the operating state detector. The controller decreases the supply amount of the second fuel to be supplied to the combustion chamber when the operating state detector detects a transient operating state of the internal combustion engine.

### FIELD

The present disclosure relates to a control device and method for an internal combustion engine.

### BACKGROUND

Internal combustion engines are driven by combustion energy combusted and generated by injecting fuel into high-pressure air in a combustion chamber. In recent years, the use of carbon-free fuels that produce less harmful substances (e.g., carbon dioxide) as fuels to be used for internal combustion engines has been considered.

However, some carbon-free fuels have poor ignitability and combustibility, and it has been suggested that they be used with fuels having good ignitability and combustibility. An internal combustion engine that uses a plurality of kinds of fuels is described in, for example, Patent Literature 1.

The diesel engine described in Patent Literature 1 allows fuel oil and ammonia to be supplied to the combustion chamber, making an excess air ratio lower than in operation with fuel oil alone.

### CITATION LIST

### Patent Literature

[Patent Literature 1] Japanese Patent Application Laid-open No. 2021-188574

### SUMMARY

### Technical Problem

In general, internal combustion engines that use a first fuel such as diesel fuel and a second fuel such as ammonia, which has poorer ignitability and combustibility than the first fuel, are designed or controlled such that the excess air ratio on an ammonia pre-mixture is at a proper value in order to prevent cylinder pressure from being exceeded due to a sudden rise in a burning velocity or pre-ignition during a steady-state operation. However, during a high-load operation of the internal combustion engine, for example, if the number of revolutions of a supercharger does not follow and an air volume decreases, the injection ratio of the second fuel may increase, resulting in a low excess air ratio, and the cylinder pressure may be excessive. In addition, when the excess air ratio decreases, an oxygen amount in a catalyst provided in an exhaust path may be insufficient, making it difficult to process unburned ammonia.

The present disclosure solves the above problems, and an object thereof is to provide a control device and method for an internal combustion engine that suppresses excessive cylinder pressure due to a sudden rise in a burning velocity or pre-ignition.

### Solution to Problem

To achieve the above object, a control device according to the present disclosure is for an internal combustion engine that supplies to a combustion chamber a first fuel having certain ignitability and a second fuel having lower ignitability than the first fuel. The control device includes: an operating state detector that detects an operating state of the internal combustion engine; and a controller that controls supply amounts of the first fuel and the second fuel to be supplied to the combustion chamber based on the operating state of the internal combustion engine detected by the operating state detector. The controller decreases the supply amount of the second fuel to be supplied to the combustion chamber when the operating state detector detects a transient operating state of the internal combustion engine.

A method according to the present disclosure is for controlling an internal combustion engine that supplies to a combustion chamber a first fuel having certain ignitability and a second fuel having lower ignitability than the first fuel. The method includes the steps of: detecting an operating state of the internal combustion engine; controlling supply amounts of the first fuel and the second fuel to be supplied to the combustion chamber based on an operating state of the internal combustion engine; and decreasing the supply amount of the second fuel to be supplied to the combustion chamber when the operating state of the internal combustion engine enters a transient operating state.

### Advantageous Effects of Invention

According to the control device and method for an internal combustion engine of the present disclosure, it is possible to suppress excessive cylinder pressure due to a sudden rise in a burning velocity or pre-ignition.

### BRIEF DESCRIPTION OF DRAWINGS

FIG. 1 is a block diagram of a control device for an internal combustion engine of the present embodiment.

FIG. 2 is a sectional view of a combustion chamber of the internal combustion engine,

FIG. 3 is a control map represents mixed combustion ratios of a second fuel.

FIG. 4 is a flowchart of a method for controlling an internal combustion engine of the present embodiment.

FIG. 5 is an illustrative diagram for comparing conventional fuel supply control and fuel supply control of the present embodiment with each other.

### DESCRIPTION OF EMBODIMENTS

Preferred embodiments of the present disclosure will be described below in detail with reference to the drawings. Note that the present disclosure is not limited by this embodiment, and when there are a plurality of embodiments, also includes those configured by combining the embodiments. The components in the embodiments include those that can be readily assumed by those skilled in the art, those that are substantially identical, or those that are in what is called a range of equivalence.

### <Internal Combustion Engine>

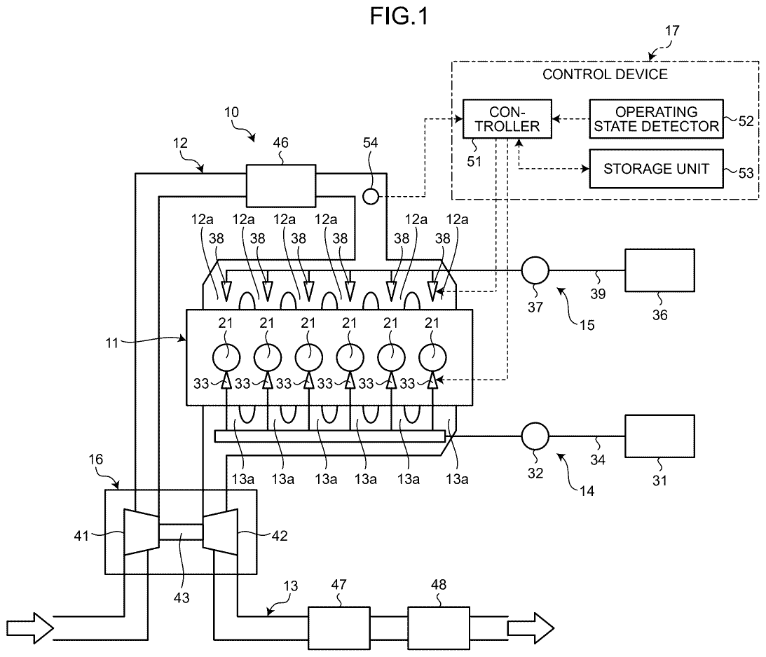

FIG. 1 is a block diagram of a control device for an internal combustion engine of a first embodiment.

As illustrated in FIG. 1, this internal combustion engine 10 includes an internal combustion engine body 11, an air intake path 12, an exhaust path 13, a first fuel supply device 14, a second fuel supply device 15, a turbocharger 16, and a control device 17.

The internal combustion engine body 11 is a multi-cylinder engine. The internal combustion engine body 11 includes a plurality of (six in the present embodiment) combustion chambers 21. The air intake path 12 is connected to respective air intake ports 12a of the respective combustion chambers 21, and the exhaust path 13 is connected to respective exhaust ports 13a of the respective combustion chambers 21. The air intake path 12 supplies air taken in from the outside to the respective combustion chambers 21 through the respective air intake ports 12a. The exhaust path 13 discharges combustion gases combusted in the respective combustion chambers 21, that is, flue gases through the respective exhaust ports 13a.

The first fuel supply device 14 supplies a first fuel to the combustion chambers 21. The first fuel supply device 14 includes a first fuel tank 31, a first fuel pump 32, first fuel injection valves 33, and a first fuel supply path 34. The first fuel tank 31 stores the first fuel. The first fuel injection valves 33 are provided in the internal combustion engine body 11, corresponding to the respective combustion chambers 21, and are capable of injecting the first fuel into the respective combustion chambers 21. The first fuel supply path 34 connects the first fuel tank 31 and the first fuel injection valves 33 to each other. The first fuel pump 32 is provided in the first fuel supply path 34 and pressurizes the first fuel to a certain injection pressure.

The second fuel supply device 15 supplies a second fuel to the combustion chambers 21. The second fuel supply device 15 includes a second fuel tank 36, a second fuel pump 37, second fuel injection valves 38, and a second fuel supply path 39. The second fuel tank 36 stores the second fuel. The second fuel injection valves 38 are provided in the internal combustion engine body 11, corresponding to the respective air intake ports 12a, and are capable of injecting the second fuel into the respective air intake ports 12a. The second fuel supply path 39 connects the second fuel tank 36 and the second fuel injection valves 38 to each other. The second fuel pump 37 is provided in the second fuel supply path 39 and pressurizes the second fuel to a certain injection pressure.

The first fuel has certain ignitability (combustibility). The second fuel has lower ignitability (combustibility) than the first fuel. In the present embodiment, the first fuel is, for example, diesel fuel, and the second fuel is, for example, ammonia. Ammonia is a carbon-free fuel emitting less carbon dioxide and other greenhouse gases than hydrocarbon fuels. However, the first fuel and the second fuel are not limited to diesel fuel and ammonia. The second fuel may be methanol, natural gas, or the like.

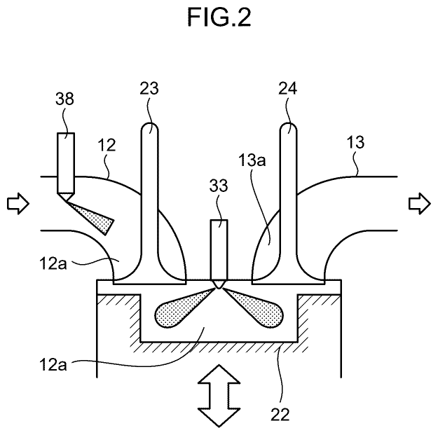

FIG. 2 is a sectional view of the combustion chamber of the internal combustion engine.

As illustrated in FIG. 2, the internal combustion engine body 11 is provided with the combustion chamber 21. Both the air intake path 12 and the exhaust path 13 are connected to the combustion chamber 21. The combustion chamber 21 is a cylindrical space in which a cylindrical piston 22 is movably supported. The internal combustion engine body 11 has a crankshaft, not shown, rotatably supported at its lower part, and the piston 22 and the crankshaft are coupled to each other via a connecting rod.

The combustion chamber 21 is a space sectioned by the internal combustion engine body 11 and the piston 22. The combustion chamber 21 communicates with the air intake path 12 via the air intake port 12a and communicates with the exhaust path 13 via the exhaust port 13a. The air intake port 12a is where the lower end of an air intake valve 23 is disposed, and the exhaust port 13a is where the lower end of an exhaust valve 24 is disposed. The air intake valve 23 and the exhaust valve 24 are movably supported by the internal combustion engine body 11 along an axial direction and are biased to a direction to close the air intake port 12a and the exhaust port 13a by a biasing member (not illustrated). The air intake valve 23 and the exhaust valve 27 open and close the air intake port 12a and the exhaust port 13a by the action of an air intake cam and an exhaust cam which are not illustrated.

In the internal combustion engine body 11, the first fuel injection valve 33 is disposed above the combustion chamber 21. The first fuel injection valve 33 injects the high-pressure first fuel into the combustion chamber 21 at a certain timing. In the internal combustion engine body 11, the second fuel injection valve 38 is disposed near the air intake port 12a. The second fuel injection valve 38 injects the high-pressure second fuel into the air intake port 12a at a certain timing.

Referring back to FIG. 1, the turbocharger 16 includes a compressor 41 and a turbine 42 coupled to each other to rotate together by a rotary shaft 43. The compressor 41 is disposed in the air intake path 12 and the turbine 42 is disposed in the exhaust path 13. In the turbocharger 16, flue gas flowing through the exhaust path 13 rotates the turbine 42, and the rotation of the turbine 42 is transmitted by the rotary shaft 43 to the compressor 41, thereby rotating the compressor 41, and the compressor 41 compresses air and supplies the air to the air intake path 12.

In the present embodiment, the internal combustion engine 10 is configured with the turbocharger 16, but may be configured without the turbocharger 16. The exhaust path 13 may be provided with an exhaust bypass device. The exhaust bypass device includes a wastegate valve provided in a bypass passage that bypasses the turbine 42.

The exhaust bypass device opens and closes the bypass passage in accordance with intake air pressure in an air intake passage to adjust the amount of flue gas to be supplied to the turbine 42.

The air intake path 12 is also installed with an intercooler 46. In addition, the exhaust path 13 is provided with an SCR catalyst (a selective catalytic reduction and denitrification device) 47 and an ASC catalyst (an ammonia slip catalyst) 48. The SCR catalyst 47 removes nitrogen oxide (NOx) and the like in the flue gas. The ASC catalyst 48 removes ammonia (NH3) and the like in the flue gas.

As illustrated in FIG. 1 and FIG. 2, when air is supplied to the combustion chamber 21 from the air intake path 12, the internal combustion engine 10 raises the piston 22, thereby compressing the air. The first fuel is supplied to the combustion chamber 21 by the first fuel supply device 14, and the second fuel is supplied to the air intake port 12a by the second fuel supply device 15. When the first fuel and the second fuel are ignited in the combustion chamber 21, the fuel and the air combust to activate the piston 22. The combustion gas generated in the combustion chamber 21 is discharged as flue gas into the exhaust path 13. The flue gas discharged from the combustion chamber 21 into the exhaust path 13 rotates the turbine 42 of the turbocharger 16, which rotates the compressor 41 via the rotary shaft 43 to compress air and performs turbo-charging for the combustion chamber 21 through the air intake path 12.

### <Control Device for Internal Combustion Engine>

As illustrated in FIG. 1, the control device 17 controls the internal combustion engine body 11. Specifically, the control device 17 controls the opening and closing timing of the fuel injection valves 33 and 38, the amount of fuel injected by the fuel injection valves 33 and 38 (an open period of the fuel injection valves), the opening and closing timing of the air intake port 12a and the exhaust port 13a by the air intake valve 23 and the exhaust valve 24, and the like.

The control device 17 includes a controller 51, an operating state detector 52, and a storage unit 53. The controller 51 is connected to the first fuel injection valve 33 and the second fuel injection valve 38. To the controller 51, the operating state detector 52 and the storage unit 53 are connected. The air intake path 12 is provided with an intake air pressure sensor 54 downstream from the intercooler 46. The intake air pressure sensor 54 is connected to the controller 51.

The operating state detector 52 detects an operating state of the internal combustion engine body 11 and outputs the detected operating state of the internal combustion engine body 11 to the controller 51. The storage unit 53 stores therein computer programs necessary to control the internal combustion engine body 11. The intake air pressure sensor 54 detects the pressure of air flowing through the air intake path 12 and outputs the detected pressure of the air to the controller 51.

The controller 51 is a controller, which is implemented by, for example, a central processing unit (CPU), a micro processing unit (MPU), or the like executing the various computer programs stored in the storage unit 53, using a RAM as a work area.

The controller 51 controls the supply amounts of the first fuel and the second fuel to be supplied to the combustion chamber 21 based on the operating state of the internal combustion engine body 11 detected by the operating state detector 52. That is, the controller 51 controls the first fuel injection valve 33 to adjust the supply amount of the first fuel to be supplied to the combustion chamber 21 and also controls the second fuel injection valve 38 to adjust the supply amount of the second fuel to be supplied to the combustion chamber 21 based on the operating state of the internal combustion engine body 11 detected by the operating state detector 52.

When the operating state detector 52 detects a transient operating state of the internal combustion engine body 11, the controller 51 decreases the supply amount of the second fuel to be supplied to the combustion chamber 21. Specifically, when the operating state detector 52 detects the transient operating state of the internal combustion engine body 11, the controller 51 decreases the supply amount of the second fuel to be supplied to the combustion chamber 21 and increases the supply amount of the first fuel to be supplied to the combustion chamber 21.

The controller 51 sets a fuel injection amount, that is, a heat value based on the operating state (an operating load) of the internal combustion engine body 11, and sets an injection amount of the first fuel and an injection amount of the second fuel. At this time, when the internal combustion engine body 11 is in the transient operating state, the injection amount of the second fuel is decreased and the injection amount of the first fuel is increased while maintaining a fuel heat value.

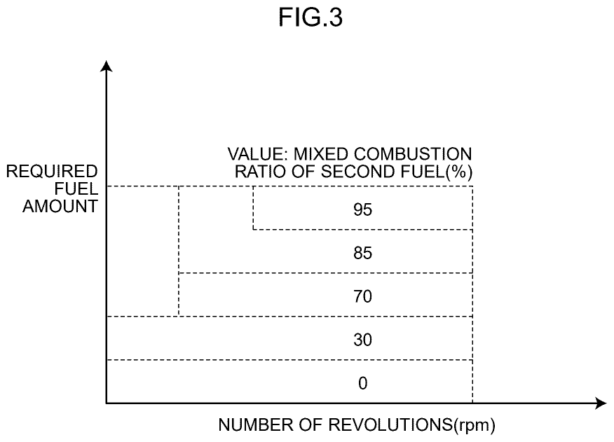

FIG. 3 is a control map represents the mixed combustion ratios of the second fuel.

As illustrated in FIG. 3, the control map representing the mixed combustion ratios of a fuel is the mixed combustion ratios of the second fuel corresponding to the number of revolutions and a required fuel amount of the internal combustion engine body 11, and the mixed combustion ratio of the second fuel is the proportion of the second fuel to the total amount of the fuel to be supplied to the combustion chamber 21. The mixed combustion ratio of the second fuel is set to increase as the number of revolutions of the internal combustion engine body 11 increases. Note that the mixed combustion ratios in the control map illustrated in FIG. 3 are mixed combustion ratios in terms of heat value in the first fuel and the second fuel.

As illustrated in FIG. 1, the control map representing the mixed combustion ratios of the second fuel (mixed combustion ratio map) is stored in the storage unit 53. When the operating state detector 52 detects a steady-state operating state of the internal combustion engine body 11, the controller 51 sets the supply amount of the first fuel and the supply amount of the second fuel to be supplied to the combustion chamber 21 based on the mixed combustion ratio map. When the operating state detector 52 detects the transient operating state of the internal combustion engine body 11, the controller 51 sets the supply amount of the second fuel to be supplied to the combustion chamber 21 (mixed combustion ratio) to zero, without using the mixed combustion ratio map.

Note that when the operating state detector 52 detects the transient operating state of the internal combustion engine body 11, the controller 51 sets the supply amount of the second fuel to be supplied to the combustion chamber 21 (mixed combustion ratio) to zero, but this configuration is not limiting. For example, a second mixed combustion ratio map in which the mixed combustion ratios of the second fuel are decreased by a certain rate with respect to the control map representing the mixed combustion ratio of a fuel illustrated in FIG. 3 may be set, the second mixed combustion ratio map may be stored in the storage unit 53, and the controller 51 may set the supply amount of the second fuel to be supplied to the combustion chamber 21 (mixed combustion ratio) based on the second mixed combustion ratio map in the storage unit 53.

The transient operating state described above is a state in which the internal combustion engine body 11 is operated at a higher load than normal. When the load of the internal combustion engine body 11 is higher than a preset determination value, the operating state detector 52 determines that the internal combustion engine body 11 is in a high-load operating state, that is, the transient operating state. Specifically, the operating state detector 52 makes a determination based on the actual load condition and/or indicated value of the load of the internal combustion engine body 11. The load is the actual measured value or indicated value of accelerator opening, the number of revolutions, a fuel injection amount, output, cylinder pressure, or the like, and the load change is the change rate of these values. The load change may be an environmental condition change.

The load of the internal combustion engine body 11 may be an excess air ratio. That is, the operating state detector 52 is a sensor that detects the excess air ratio in the internal combustion engine body 11, and the controller 51 may decrease the supply amount of the second fuel to be supplied to the combustion chamber 21 when the excess air ratio becomes a preset proper range or less.

### <Method for Controlling Internal Combustion Engine>

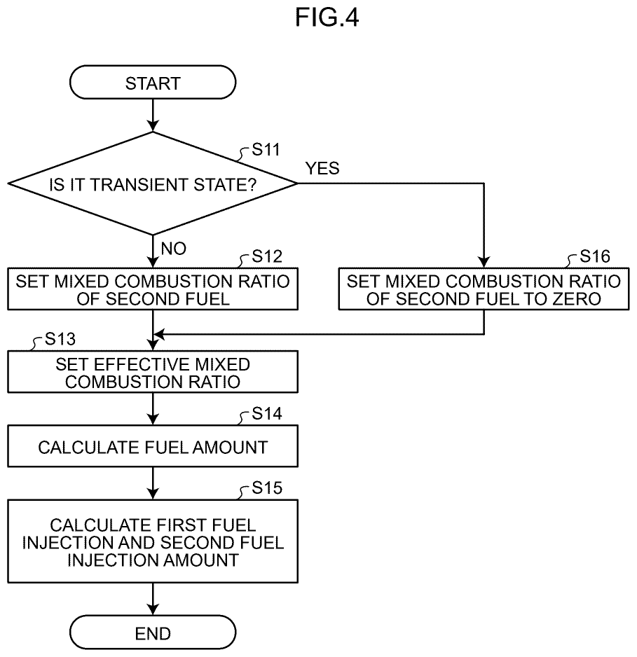

FIG. 4 is a flowchart of a method for controlling an internal combustion engine of the present embodiment.

As illustrated in FIG. 1 and FIG. 4, at Step S11, the controller 51 determines whether the internal combustion engine body 11 is in the transient operating state based on a detection result of the operating state detector 52. The controller 51 moves to Step S12 if it determines that the internal combustion engine body 11 is not in the transient operating state (No), and moves to Step S16 if it determines that the internal combustion engine body 11 is in the transient operating state (Yes).

When the internal combustion engine body 11 is not in the transient operating state, at Step S12, the controller 51 sets the mixed combustion ratio of the second fuel using the mixed combustion ratio map (refer to FIG. 3). On the other hand, when the internal combustion engine body 11 is in the transient operating state, at Step S16, the controller 51 sets the mixed combustion ratio of the second fuel to zero. However, when the internal combustion engine body 11 is in the transient operating state, the mixed combustion ratio may be set to decrease the injection amount of the second fuel using the second mixed combustion ratio map, as described above.

At Step S13, the controller 51 sets an effective mixed combustion ratio in terms of heat value based on the processing results at Steps S12 and S16. At Step S14, the controller 51 calculates an overall fuel injection amount in accordance with the effective mixed combustion ratio. At Step S15, the controller 51 calculates a first fuel injection amount and a second fuel injection amount.

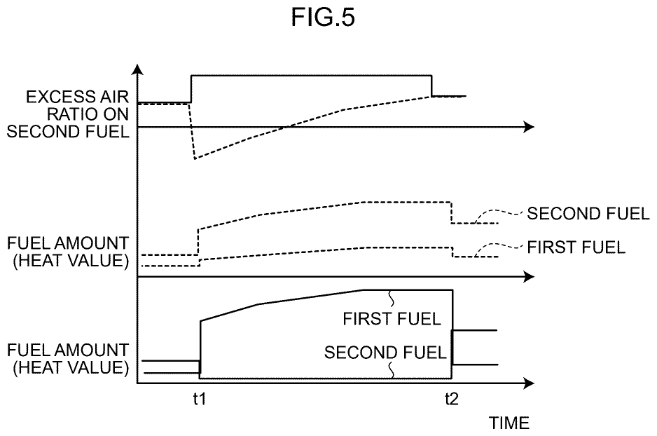

FIG. 5 is an illustrative diagram for comparing conventional fuel supply control and fuel supply control of the present embodiment with each other. In FIG. 5, the conventional fuel supply control is represented by dotted lines, and the fuel supply control of the present embodiment is represented by solid lines.

As illustrated in FIG. 1 and FIG. 5, when a total fuel injection amount of the first fuel and the second fuel rises at time t1, the internal combustion engine body 11 enters the transient operating state. At this time, in the conventional fuel supply control, an intake air amount decreases to reduce the excess air ratio on the second fuel. Then, since the intake air amount increases over time, the excess air ratio increases and returns to a proper value. Subsequently, at time t2, the internal combustion engine body 11 enters the steady-state operating state.

On the other hand, in the fuel supply control of the present embodiment, when the internal combustion engine body 11 enters the transient operating state at time t1, the fuel injection amount of the second fuel is decreased and the fuel injection amount of the first fuel is increased. Therefore, the decrease in the excess air ratio is curbed.

Subsequently, at time t2, the internal combustion engine body 11 enters the steady-state operating state. Thus, an excess of cylinder pressure due to a sudden rise in a burning velocity or pre-ignition due to the decrease in the excess air ratio on the second fuel is suppressed.

### [Effects of Present Disclosure]

A control device for an internal combustion engine according to a first aspect includes, in the internal combustion engine 10 that supplies a first fuel having certain ignitability and a second fuel having lower ignitability than the first fuel to the combustion chamber 21, the operating state detector 52 that detects the operating state of the internal combustion engine body 11, and the controller 51 that controls the supply amounts of the first fuel and the second fuel to be supplied to the combustion chamber 21 based on the operating state of the internal combustion engine body 11 detected by the operating state detector 52. The controller 51 decreases the supply amount of the second fuel to be supplied to the combustion chamber 21 when the operating state detector 52 detects the transient operating state of the internal combustion engine body 11.

According to the control device for an internal combustion engine according to the first aspect, when the internal combustion engine body 11 enters the transient operating state and the intake air amount decreases, the excess air ratio on the second fuel may become low and the cylinder pressure may be excessive. However, the controller 51 decreases the supply amount of the second fuel when the internal combustion engine body 11 enters the transient operating state, and thus the decrease in the excess air ratio on the second fuel is curbed. As a result, it is possible to suppress the cylinder pressure from being excessive due to a sudden rise in a burning velocity or pre-ignition in the internal combustion engine body 11. In addition, since the decrease in the excess air ratio is curbed, an oxygen amount deficiency in the SCR catalyst 47 and the ASC catalyst 48 provided in the exhaust path 13 is suppressed, and the emission of harmful substances can be appropriately suppressed.

A control device for an internal combustion engine according to a second aspect is the control device for an internal combustion engine according to the first aspect, in which the controller 51 decreases the supply amount of the second fuel to be supplied to the combustion chamber 21 and increases the supply amount of the first fuel to be supplied to the combustion chamber 21 when the operating state detector 52 detects the transient operating state of the internal combustion engine body 11. This allows the supply amount of the first fuel to increase against the decrease in the supply amount of the second fuel, and can thus curb a decrease in the output of the internal combustion engine body 11.

A control device for an internal combustion engine according to a third aspect is the control device for an internal combustion engine according to the second aspect, in which the controller 51 maintains a fuel heat value set in accordance with the transient operating state when the operating state detector 52 detects the transient operating state of the internal combustion engine body 11, and the controller 51 decreases the supply amount of the second fuel to be supplied to the combustion chamber 21 and increases the supply amount of the first fuel to be supplied to the combustion chamber 21. This can reduce output fluctuations in the internal combustion engine body 11.

A control device for an internal combustion engine according to a fourth aspect is the control device for an internal combustion engine according to any one of the first aspect to the third aspect, in which a mixed combustion ratio map in which a mixed combustion ratio of the second fuel is set in accordance with the number of revolutions of the internal combustion engine body 11 is set, and the controller 51 sets the supply amount of the first fuel and the supply amount of the second fuel to be supplied to the combustion chamber 21 based on the mixed combustion ratio map when the operating state detector 52 detects the steady-state operating state of the internal combustion engine body 11, and sets the supply amount of the second fuel to be supplied to the combustion chamber 21 to zero when the operating state detector 52 detects the transient operating state of the internal combustion engine body 11. This can simplify the control.

A control device for an internal combustion engine according to a fifth aspect is the control device for an internal combustion engine according to any one of the first aspect to the fourth aspect, in which the operating state detector 52 detects the excess air ratio, and the controller 51 decreases the supply amount of the second fuel to be supplied to the combustion chamber 21 when the excess air ratio becomes the preset proper range or less. This causes the controller 51 to directly detect the excess air ratio, and can thereby appropriately suppress the cylinder pressure from being excessive due to a sudden rise in a burning velocity or pre-ignition in the internal combustion engine body 11.

A method for controlling an internal combustion engine according to a sixth aspect, in the internal combustion engine 10 that supplies the first fuel having certain ignitability and the second fuel having lower ignitability than the first fuel to the combustion chamber, the method including a step of detecting the operating state of the internal combustion engine body 11, a step of controlling the supply amounts of the first fuel and the second fuel to be supplied to the combustion chamber 21 based on the operating state of the internal combustion engine body 11, and a step of decreasing the supply amount of the second fuel to be supplied to the combustion chamber 21 when the operating state of the internal combustion engine body 11 enters the transient operating state. This can curb the decrease in the excess air ratio and suppress the cylinder pressure from being excessive due to a sudden rise in a burning velocity or pre-ignition in the internal combustion engine body 11.

### REFERENCE SIGNS LIST

10 Internal combustion engine
11 Internal combustion engine body
12 Air intake path
13 Exhaust path
14 First fuel supply device
15 Second fuel supply device
16 Supercharger
17 Control device
21 Combustion chamber
31 First fuel tank
32 First fuel pump
33 First fuel injection valve
34 First fuel supply path
36 Second fuel tank
37 Second fuel pump
38 Second fuel injection valve
39 Second fuel supply path
51 Controller
52 Operating state detector
53 Storage unit
54 Intake air pressure sensor

1. A control device for an internal combustion engine that supplies to a combustion chamber a first fuel having certain ignitability and a second fuel having lower ignitability than the first fuel, the control device comprising:
an operating state detector that detects an operating state of the internal combustion engine; and
a controller that controls supply amounts of the first fuel and the second fuel to be supplied to the combustion chamber based on the operating state of the internal combustion engine detected by the operating state detector,
the controller decreasing the supply amount of the second fuel to be supplied to the combustion chamber when the operating state detector detects a transient operating state of the internal combustion engine.

2. The control device for an internal combustion engine according to claim 1, wherein the controller decreases the supply amount of the second fuel to be supplied to the combustion chamber and increases the supply amount of the first fuel to be supplied to the combustion chamber when the operating state detector detects the transient operating state of the internal combustion engine.

3. The control device for an internal combustion engine according to claim 2, wherein the controller maintains a fuel heat value set in accordance with the transient operating state when the operating state detector detects the transient operating state of the internal combustion engine, and the controller decreases the supply amount of the second fuel to be supplied to the combustion chamber and increases the supply amount of the first fuel to be supplied to the combustion chamber.

4. The control device for an internal combustion engine according to claim 1. wherein
a mixed combustion ratio map in which a mixed combustion ratio of the second fuel is set in accordance with a number of revolutions of the internal combustion engine is set, and
the controller sets the supply amount of the first fuel and the supply amount of the second fuel to be supplied to the combustion chamber based on the mixed combustion ratio map when the operating state detector detects a steady-state operating state of the internal combustion engine, and sets the supply amount of the second fuel to be supplied to the combustion chamber to zero when the operating state detector detects the transient operating state of the internal combustion engine.

5. The control device for an internal combustion engine according to claim 1, wherein
the operating state detector detects an excess air ratio, and
the controller decreases the supply amount of the second fuel to be supplied to the combustion chamber when the excess air ratio becomes a preset proper range or less.

6. A method for controlling an internal combustion engine that supplies to a combustion chamber a first fuel having certain ignitability and a second fuel having lower ignitability than the first fuel, the method comprising the steps of:
detecting an operating state of the internal combustion engine;
controlling supply amounts of the first fuel and the second fuel to be supplied to the combustion chamber based on an operating state of the internal combustion engine; and
decreasing the supply amount of the second fuel to be supplied to the combustion chamber when the operating state of the internal combustion engine enters a transient operating state.
